(19) United States
(12) Patent Application Publication
(10) Pub. No.: US 2026/0302426 A1
(43) Pub. Date: Oct. 1, 2026

(54) BATTERY DETOXIFICATION APPARATUS

(71) Applicant: SUBARU CORPORATION, Tokyo (JP)

(72) Inventor: Ryuya SUZUKI, Tokyo (JP)

(21) Appl. No.: 19/676,997

(22) Filed: May 14, 2026

Related U.S. Application Data
(63) Continuation of application No. PCT/JP2023/043535, filed on Dec. 5, 2023.

(51) Int. Cl. H01M 10/6569; B60L 50/64; B60L 58/26; H01M 10/48; H01M 10/613; H01M 10/625; H01M 10/637; H01M 10/6557

(52) U.S. Cl. CPC H01M 10/6569; B60L 50/64; B60L 58/26; H01M 10/482; H01M 10/613; H01M 10/625; H01M 10/637; H01M 10/6557; B60L 2240/545; H01M 2220/20

(57) ABSTRACT

A battery detoxification apparatus includes a medium circulator, a medium cooler, a detector, and a calculation processor. The medium circulator is disposed between battery cells. The medium circulator is configured to allow a cooling medium to circulate therethrough. The battery cells each include a sulfide. The medium cooler is configured to cool the cooling medium. The detector is configured to detect generation of hydrogen sulfide from the battery cells. The calculation processor is configured to, when the detector detects the generation of the hydrogen sulfide, perform control of generating condensation on a surface of the medium circulator by circulating the cooling medium cooled by the medium cooler through the medium circulator.

### CROSS-REFERENCE TO RELATED APPLICATIONS

This application is continuation of International Application No. PCT/JP2023/043535, filed on December 5, 2023, the entire contents of which are hereby incorporated by reference.

### BACKGROUND

The disclosure relates to a battery detoxification apparatus.

In recent years, there has been an advent of a vehicle including a large battery with which a motor is driven. As such a battery, a liquid lithium-ion battery is currently adopted.

Adoption of an all-solid-state lithium-ion battery as the battery is effective in promoting a higher battery capacity and higher energy density. The all-solid-state lithium-ion battery has a configuration including a ternary or other positive electrode material, a solid electrolyte, and a carbon or other negative electrode. The solid electrolyte is roughly classified into two types, i.e., an oxide solid electrolyte and a sulfide solid electrolyte. Among these solid electrolytes, the sulfide solid electrolyte is believed to be suitable for a battery having a high capacity and a high output for a vehicle such as an electric vehicle. However, the sulfide solid electrolyte including sulfur as a material can generate toxic gas such as hydrogen sulfide when reacting with air moisture.

Japanese Unexamined Patent Application Publication (JP-A) No. 2011-113803 discloses an all-solid-state battery that is able to absorb and detoxify hydrogen sulfide gas generated from an electric power generation element. For example, the all-solid-state battery disclosed in JP-A No. 2011-113803 includes a housing that houses the electric power generation element. Inside the housing is disposed a hydrogen sulfide detoxifying agent. The hydrogen sulfide detoxifying agent detoxifies hydrogen sulfide generated from a sulfide solid electrolyte including sulfur.

### SUMMARY

An aspect of the disclosure provides a battery detoxification apparatus configured to be applied to a vehicle. The battery detoxification apparatus includes a medium circulator, a medium cooler, a detector, and a calculation processor. The medium circulator is disposed between battery cells. The medium circulator is configured to allow a cooling medium to circulate therethrough. The battery cells each include a sulfide. The medium cooler is configured to cool the cooling medium. The detector is configured to detect generation of hydrogen sulfide from the battery cells. The calculation processor is configured to, when the detector detects the generation of the hydrogen sulfide, perform control of generating condensation on a surface of the medium circulator by circulating the cooling medium cooled by the medium cooler through the medium circulator.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a side view of a vehicle including a battery detoxification apparatus according to one example embodiment of the disclosure.

FIG. 2A is a plan view of a battery pack equipped with the battery detoxification apparatus illustrated in FIG. 1.

FIG. 2B is a cross-sectional view of an exemplary medium circulator of the battery detoxification apparatus illustrated in FIG. 1.

FIG. 3A is a cross-sectional view of another exemplary medium circulator of the battery detoxification apparatus illustrated in FIG. 1.

FIG. 3B is a cross-sectional view of still another exemplary medium circulator of the battery detoxification apparatus illustrated in FIG. 1.

FIG. 4A is a block diagram illustrating an exemplary configuration of the battery detoxification apparatus illustrated in FIG. 1 to which cooling water is adopted as a cooling medium.

FIG. 4B is a cross-sectional view of an exemplary medium circulator of the battery detoxification apparatus illustrated in FIG. 4A.

FIG. 5A is a block diagram illustrating another exemplary configuration of the battery detoxification apparatus illustrated in FIG. 1 to which the cooling water is adopted as the cooling medium.

FIG. 5B is a cross-sectional view of an exemplary medium circulator of the battery detoxification apparatus illustrated in FIG. 5A.

FIG. 6A is a block diagram illustrating still another exemplary configuration of the battery detoxification apparatus illustrated in FIG. 1 to which the cooling water is adopted as the cooling medium.

FIG. 6B is a cross-sectional view of an exemplary medium circulator of the battery detoxification apparatus illustrated in FIG. 6A.

FIG. 7A is a block diagram illustrating an exemplary configuration of the battery detoxification apparatus illustrated in FIG. 1 to which a refrigerant is adopted as the cooling medium.

FIG. 7B is a cross-sectional view of an exemplary medium circulator of the battery detoxification apparatus illustrated in FIG. 7B.

FIG. 8A is a block diagram illustrating another exemplary configuration of the battery detoxification apparatus illustrated in FIG. 1 to which the refrigerant is adopted as the cooling medium.

FIG. 8B is a cross-sectional view of an exemplary medium circulator of the battery detoxification apparatus illustrated in FIG. 8A.

FIG. 9A is a block diagram illustrating still another exemplary configuration of the battery detoxification apparatus illustrated in FIG. 1 to which the refrigerant is adopted as the cooling medium.

FIG. 9B is a cross-sectional view of an exemplary medium circulator of the battery detoxification apparatus illustrated in FIG. 9A.

FIG. 10A is a block diagram illustrating yet another exemplary configuration of the battery detoxification apparatus illustrated in FIG. 1 to which the refrigerant and the cooling water are adopted as the cooling medium.

FIG. 10B is a cross-sectional view of an exemplary medium circulator of the battery detoxification apparatus illustrated in FIG. 10A.

FIG. 11A is a block diagram illustrating yet another exemplary configuration of the battery detoxification apparatus illustrated in FIG. 1 to which the refrigerant and the cooling water are adopted as the cooling medium.

FIG. 11B is a cross-sectional view of an exemplary medium circulator of the battery detoxification apparatus illustrated in FIG. 11A.

FIG. 12A is a block diagram illustrating yet another exemplary configuration of the battery detoxification apparatus illustrated in FIG. 1 to which the refrigerant and the cooling water are adopted as the cooling medium.

FIG. 12B is a cross-sectional view of an exemplary medium circulator of the battery detoxification apparatus illustrated in FIG. 12A.

FIG. 13A is a block diagram illustrating yet another exemplary configuration of the battery detoxification apparatus illustrated in FIG. 1 to which the refrigerant is adopted as the cooling medium.

FIG. 13B is a cross-sectional view of an exemplary medium circulator of the battery detoxification apparatus illustrated in FIG. 13A.

FIG. 14A is a block diagram illustrating yet another exemplary configuration of the battery detoxification apparatus illustrated in FIG. 1 to which the refrigerant is adopted as the cooling medium.

FIG. 14B is a cross-sectional view of an exemplary medium circulator of the battery detoxification apparatus illustrated in FIG. 14A.

FIG. 15 is a flowchart illustrating an exemplary method of detoxifying hydrogen sulfide generated from a battery with the battery detoxification apparatus illustrated in FIG. 1.

### DETAILED DESCRIPTION

A technique disclosed in JP-A No. 2011-113803 has room for improvement in effective detoxification of hydrogen sulfide.

For example, the technique disclosed in JP-A No. 2011-113803 adopts a substance such as an alkaline substance or activated carbon as a hydrogen sulfide detoxifying agent that detoxifies hydrogen sulfide. However, inclusion of the hydrogen sulfide detoxifying agent necessitates a component such as a holder that holds the hydrogen sulfide detoxifying agent. This results in a complicated battery configuration, lower space efficiency, and a high cost.

It is desirable to provide a battery detoxification apparatus that allows detoxification of hydrogen sulfide with a simple configuration.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

In the following, a battery detoxification apparatus 20 and a vehicle 10 according to some example embodiments of the disclosure will be described in detail with reference to the drawings. Note that directions of front, rear, up, down, left, and right are used in the following description in such a manner that the left and the right respectively denote the left and the right of the vehicle 10 as viewed from the front.

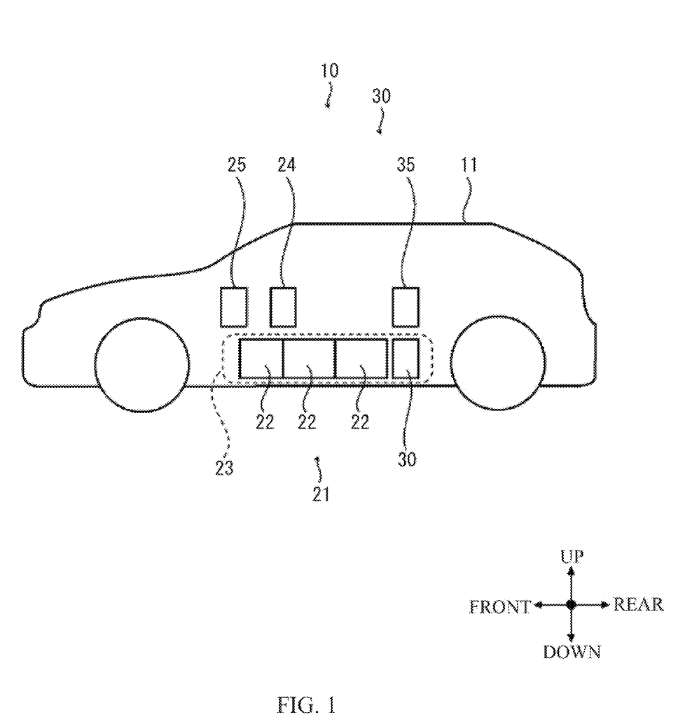

FIG. 1 is a side view of the vehicle 10 including the battery detoxification apparatus 20.

The vehicle 10 may be any vehicle such as a battery electric vehicle (BEV), a hybrid electric vehicle (HEV), or a plug-in hybrid electric vehicle (PHEV). In the present example embodiment, the vehicle 10 may include a vehicle body 11, a battery pack 21, and the battery detoxification apparatus 20.

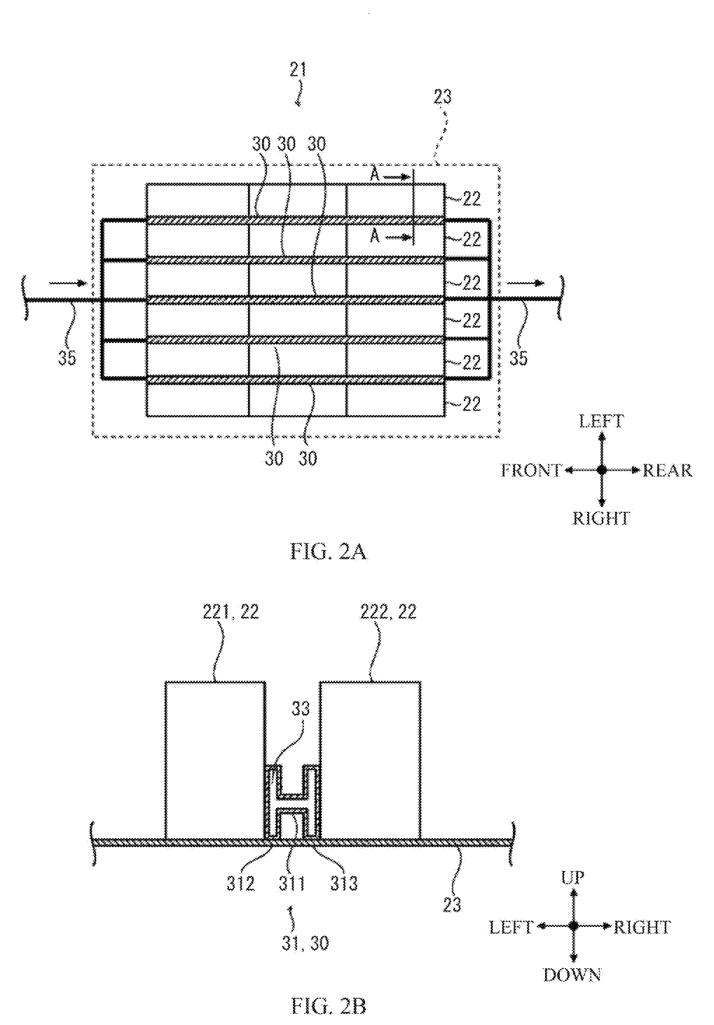

The battery pack 21 includes multiple battery cells 22 housed in a battery pack housing 23. Details of the battery pack 21 will be described later with reference to FIG. 2A. The vehicle 10 may obtain a driving force for the vehicle body 11 by rotating a motor with electric power supplied from the battery cells 22.

The battery detoxification apparatus 20 is configured to detoxify hydrogen sulfide generated inside the battery pack 21. The battery detoxification apparatus 20 includes a medium circulator 30, a medium cooler 35, a detector 25, and a calculation processor 24.

The medium circulator 30 is disposed between the battery cells 22 including a sulfide. The medium circulator 30 is configured to allow a later-described cooling medium 33 to circulate therethrough. Details of the medium circulator 30 will be described later with reference to FIG. 2A, for example.

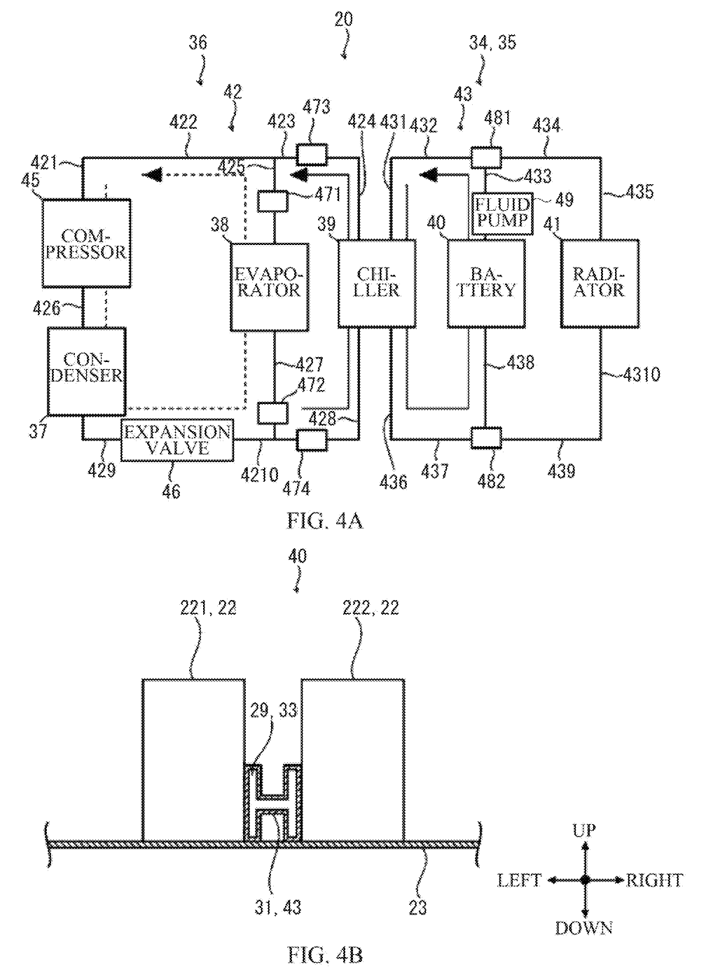

The medium cooler 35 is configured to cool the cooling medium 33. Details of the medium cooler 35 will be described later with reference to FIG. 4A, for example.

The detector 25 is configured to detect generation of hydrogen sulfide from the battery cells 22. In some embodiments, the detector 25 may be any device configured to directly detect the generation of hydrogen sulfide, such as a hydrogen sulfide sensor disposed inside the battery pack housing 23 to be described later. In some embodiments, the detector 25 may be any device configured to indirectly detect the generation of hydrogen sulfide, such as a device that detects data including a temperature of the battery cells 22, a deformation amount of the battery cells 22, and contact of the vehicle 10.

The calculation processor 24 may include a semiconductor device such as a central processing unit (CPU). The calculation processor 24 may include a semiconductor storage device such as a random-access memory (RAM) or a read-only memory (ROM) as a storage. The storage may hold data including a program and a parameter. The calculation processor 24 may execute an exemplary operation and method to be described later, based on the data including the program and the parameter read from the storage. In the present example embodiment, upon the detector 25 detecting the generation of hydrogen sulfide, the calculation processor 24 circulates the cooling medium 33 cooled by the medium cooler 35 through the medium circulator 30 to thereby detoxify hydrogen sulfide, as described later.

FIG. 2A is a plan view of the battery pack 21 to be detoxified by the battery detoxification apparatus 20.

The battery pack 21 may include the battery cells 22 and the battery pack housing 23.

The battery cells 22 may be an all-solid-state battery. In the present example embodiment, the battery cells 22 may be disposed in a matrix extending in a left-right direction and an up-down direction. The battery cells 22 may be an all-solid-state lithium-ion battery including a sulfide solid electrolyte. In this case, moisture remaining inside or mixed into the battery cells 22 in a process of manufacturing the battery cells 22 may possibly cause the generation of hydrogen sulfide inside the battery cells 22 in a charge and discharge cycle in using the battery pack 21, and cause leaking of the resultant hydrogen sulfide out of the battery cells 22 due to a certain factor. In the present example embodiment, hydrogen sulfide is detoxified by generating condensation inside the battery pack housing 23 to dissolve hydrogen sulfide in condensed water caused by the condensation, as described later.

In the present example embodiment, the battery pack housing 23 may have a substantially rectangular parallelepiped shape. Inside the battery pack housing 23 may be housed components such as the battery cells 22 or the medium circulator 30. The inside of the battery pack housing 23 may be a substantially sealed space.

The medium circulator 30 is disposed between the battery cells 22. In the present example embodiment, the medium circulator 30 may be disposed between the battery cells 22 in the left-right direction. Upon the generation of hydrogen sulfide from the battery cells 22, the medium circulator 30 may be configured to generate condensation on a surface of the medium circulator 30 by lowering a temperature of the surface of the medium circulator 30. The medium circulator 30 disposed between the battery cells 22 may be further configured to absorb expansion and contraction of the battery cells 22 in charging and discharging. The medium circulator 30 may be further configured to mitigate vibration and impact to be transmitted to the battery cells 22 by absorbing the vibration and impact received from the outside. In some embodiments, the medium circulator 30 may have various cross-sectional shapes. The medium circulator 30 will be described later with reference to FIG. 2B and the subsequent drawings.

The medium circulator 30 may have a front side end and a rear side end that are each coupled to the medium cooler 35. The medium cooler 35 may be a site where the cooling medium 33 to circulate through the medium circulator 30 is cooled, as described later.

FIG. 2B is a cross-sectional view of the medium circulator 30 of the battery detoxification apparatus 20, taken along a line A-A in FIG. 2A. Illustrated in FIG. 2B is a battery cell 221 and a battery cell 222 adjacent to each other out of the battery cells 22.

In this example illustrated in FIG. 2B, the medium circulator 30 may be a separator 31 having an H-shaped cross-section. The medium circulator 30 may have a hollow structure configured to allow the cooling medium 33 to circulate therethrough. The separator 31 may include any metal material such as iron or stainless steel in light of thermal conductivity. In some embodiments, the separator 31 may include a web 311 and flanges 312 and 313. The flange 312 may have an elongated shape extending in the up-down direction and be in contact with a right-side surface of the battery cell 221. The flange 313 may have an elongated shape extending in the up-down direction and be in contact with a left-side surface of the battery cell 222. The web 311 may be a member that couples a substantially middle part in the up-down direction of the flange 312 to a substantially middle part in the up-down direction of the flange 313.

Such a configuration of the separator 31 serving also as the medium circulator 30 helps to detoxify hydrogen sulfide as described later while suppressing an increase in the number of components. Further, the medium circulator 30 having the H-shaped cross-section helps to increase a surface area of the medium circulator 30 to thereby generate a large amount of condensation. Furthermore, an upper part of the separator 31 may be usable to store the condensed water containing the dissolved hydrogen sulfide, as described later.

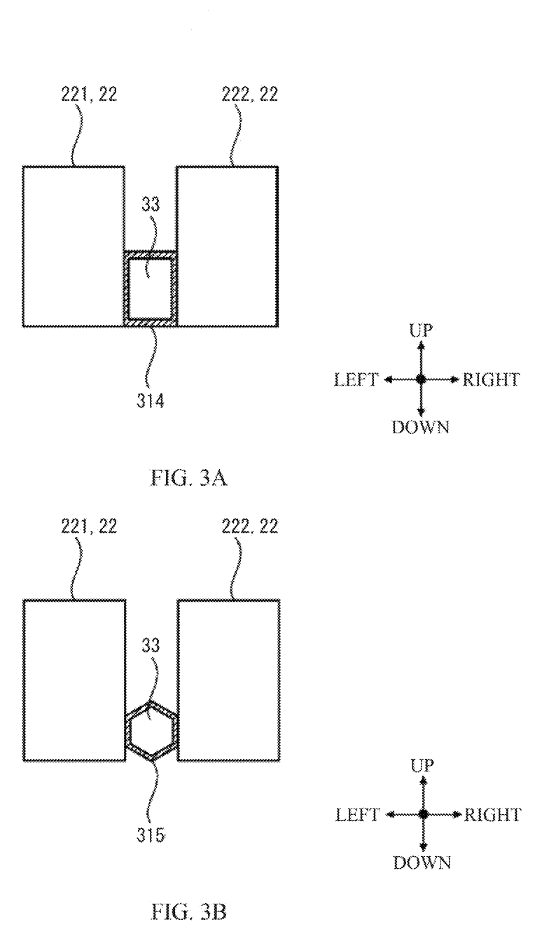

FIG. 3A is a cross-sectional view of a medium circulator 314 according to another example embodiment of the disclosure. In this example embodiment, the medium circulator 314 may have a substantially rectangular cross-sectional shape. The medium circulator 314 having the substantially rectangular cross-sectional shape helps to increase an area of the battery cell 221 and the battery cell 222 in contact with respective side surfaces of the medium circulator 314. The medium circulator 314 may also have a hollow structure configured to allow the cooling medium 33 to circulate therethrough.

FIG. 3B is a cross-sectional view of a medium circulator 315 according to still another example embodiment of the disclosure. In this example embodiment, the medium circulator 315 may have a substantially regular hexagonal cross-sectional shape. The medium circulator 315 having the substantially regular hexagonal cross-sectional shape may allow respective side surfaces opposing in the left-right direction of the medium circulator 315 to contact with respective side surfaces of the battery cell 221 and the battery cell 222. The medium circulator 315 may also have a hollow structure configured to allow the cooling medium 33 to circulate therethrough.

The battery detoxification apparatus 20 having an exemplary configuration in which a component such as a battery 40 is cooled with a radiator 41 and a refrigeration cycle 36 will be described with reference to FIGS. 4A to 6B.

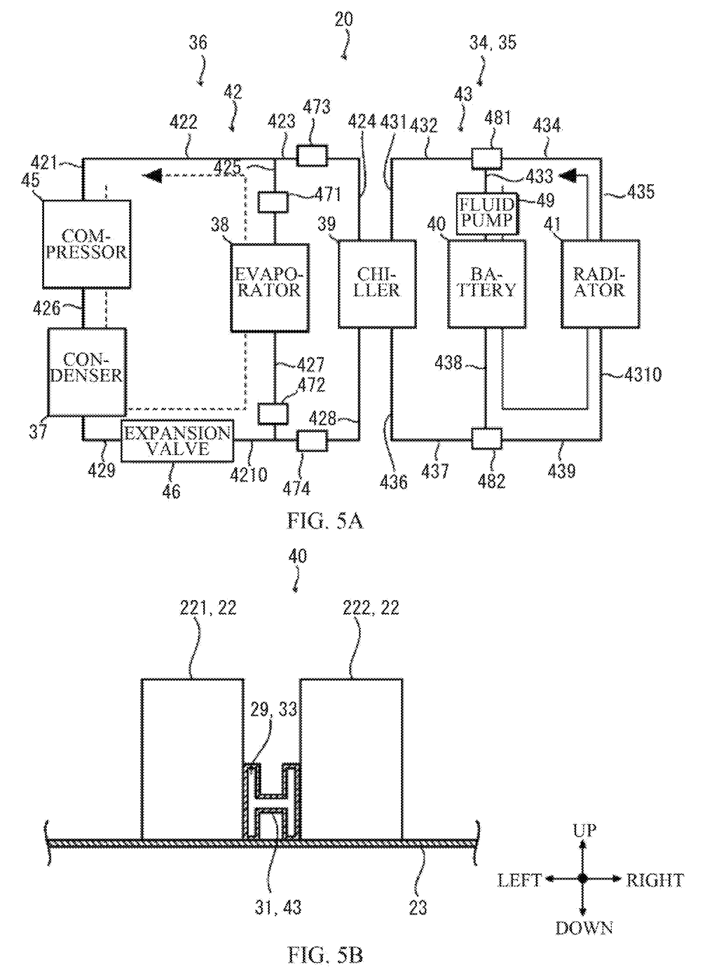

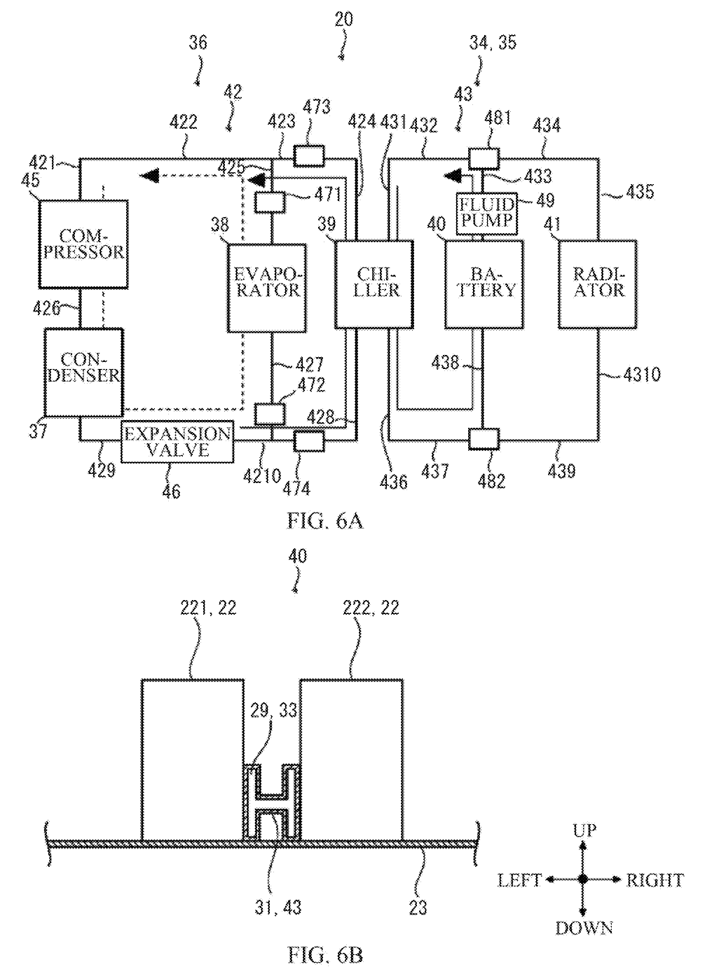

FIGS. 4A and 4B each illustrate an exemplary configuration and operation of the battery detoxification apparatus 20 in a situation where hydrogen sulfide has been generated inside the battery 40. FIGS. 5A and 5B each illustrate an exemplary configuration and operation of the battery detoxification apparatus 20 in which the refrigeration cycle 36 is operated and the battery 40 is cooled with a cooling water flow passage 43 in a normal situation where hydrogen sulfide is not generated inside the battery 40. FIGS. 6A and 6B each illustrate an exemplary configuration and operation of the battery detoxification apparatus 20 in which the refrigeration cycle 36 is operated and the battery 40 is cooled with a chiller 39 in the normal situation where hydrogen sulfide is not generated inside the battery 40.

FIG. 4A is a block diagram illustrating the exemplary operation of the battery detoxification apparatus 20 including cooling water 29 as the cooling medium 33 in the situation where hydrogen sulfide has been generated. FIG. 4B is a cross-sectional view of the battery cells 22 and the separator 31.

The exemplary configuration of the battery detoxification apparatus 20 will be described with reference to FIG. 4A. The battery detoxification apparatus 20 may include a cooling water circuit 34 and the refrigeration cycle 36. The cooling water circuit 34 may serve as the medium cooler 35 of the battery detoxification apparatus 20. This allows the cooling water 29 having circulated through the medium cooler 35 to circulate through the separator 31 illustrated in FIG. 4B.

The cooling water circuit 34 may include the chiller 39, the battery 40, the radiator 41, a fluid pump 49, and the cooling water flow passage 43. The cooling water circuit 34 may be configured to cool the inside of the battery pack housing 23 via the separator 31 with the cooling water 29 circulating through the cooling water flow passage 43. In the present example embodiment, the cooling water flow passage 43 may be a pipeline.

The chiller 39 may be a heat exchanger that cools the cooling water 29 by performing a heat exchange between a refrigerant 28 used in the refrigeration cycle 36 and the cooling water 29 used in the cooling water circuit 34. In one embodiment, the chiller 39 may serve as the "heat exchanger".

The radiator 41 may be a device that cools the cooling water 29 by performing a heat exchange between external air and the cooling water 29 circulating through the radiator 41.

The battery 40 may have a configuration similar to the configuration of the battery pack 21 as described with reference to FIG. 2A, for example.

The fluid pump 49 may be interposed in a cooling water flow path 433 to be described later and generate pressure that causes the cooling water 29 to circulate through the cooling water flow passage 43. In some embodiments, the fluid pump 49 may be disposed at an intermediate part of the cooling water flow path 433 and generate pressure that causes the cooling water 29 to flow from the cooling water flow path 433 into a cooling water flow path 432 or a cooling water flow path 434.

The battery 40, the radiator 41, and the chiller 39 may be coupled to each other by the cooling water flow passage 43 serving as a pipeline. The cooling water flow passage 43 may be a channel through which the cooling water 29 is to circulate and that includes a cooling water flow path 431, the cooling water flow path 432, the cooling water flow path 433, the cooling water flow path 434, a cooling water flow path 435, a cooling water flow path 436, a cooling water flow path 437, a cooling water flow path 438, a cooling water flow path 439, and a cooling water flow path 4310.

The cooling water flow path 431, the cooling water flow path 432, the cooling water flow path 434, and the cooling water flow path 435 may form a channel that couples the chiller 39 to the radiator 41. The cooling water flow path 433 may form a channel that couples the battery 40 to a coupling part that couples the cooling water flow path 432 to the cooling water flow path 434. The cooling water flow path 436, the cooling water flow path 437, the cooling water flow path 439, and the cooling water flow path 4310 may form a channel that couples the chiller 39 to the radiator 41. The cooling water flow path 438 may form a channel that couples the battery 40 to a coupling part that couples the cooling water flow path 437 to the cooling water flow path 439.

In the cooling water circuit 34 may be interposed a three-way valve 481 and a three-way valve 482. The three-way valve 481 and the three-way valve 482 may each switch a flow direction of the cooling water 29.

The three-way valve 481 may be disposed at a coupling part that couples the cooling water flow path 432, the cooling water flow path 434, and the cooling water flow path 433 to each other. Upon the generation of hydrogen sulfide, the three-way valve 481 may switch the flow direction of the cooling water 29 to cause the cooling water 29 having flowed from the cooling water flow path 433 to flow into the cooling water flow path 432.

The three-way valve 482 may be disposed at a coupling part that couples the cooling water flow path 437, the cooling water flow path 439, and the cooling water flow path 438 to each other. Upon the generation of hydrogen sulfide, the three-way valve 482 may switch the flow direction of the cooling water 29 to cause the cooling water 29 having flowed from the cooling water flow path 437 to flow into the cooling water flow path 438.

The refrigeration cycle 36 may be a refrigerant circuit. In some embodiments, the refrigeration cycle 36 may be a vapor-compression refrigeration cycle including a compressor 45, a condenser 37, an expansion valve 46, and an evaporator 38. The refrigeration cycle 36 may also be coupled to the chiller 39.

The compressor 45, the condenser 37, the expansion valve 46, the evaporator 38, and the chiller 39 may be coupled to each other by a refrigerant flow passage 42 serving as a pipeline. The refrigerant flow passage 42 may include a refrigerant flow path 421, a refrigerant flow path 422, a refrigerant flow path 423, a refrigerant flow path 424, a refrigerant flow path 425, a refrigerant flow path 426, a refrigerant flow path 427, a refrigerant flow path 428, a refrigerant flow path 429, and a refrigerant flow path 4210. Through the refrigerant flow passage 42 may circulate the refrigerant 28 used in the vapor-compression refrigeration cycle 36. Non-limiting examples of the refrigerant 28 may include ammonia, a hydrocarbon, and carbon dioxide.

Details of the refrigerant flow passage 42 will now be described. The refrigerant flow path 421, the refrigerant flow path 422, the refrigerant flow path 423, and the refrigerant flow path 424 may form a channel that couples the compressor 45 to the chiller 39. The refrigerant flow path 425 may form a channel that couples the evaporator 38 to a coupling part that couples the refrigerant flow path 422 to the refrigerant flow path 423. The refrigerant flow path 426 may form a channel that couples the compressor 45 to the condenser 37. The refrigerant flow path 429 may form a channel that couples the condenser 37 to the expansion valve 46. The refrigerant flow path 4210 and the refrigerant flow path 428 may form a channel that couples the expansion valve 46 to the chiller 39. The refrigerant flow path 427 may form a channel that couples the evaporator 38 to a coupling part that couples the refrigerant flow path 4210 to the refrigerant flow path 428.

In the refrigerant flow passage 42 may be disposed a switching valve 471, a switching valve 472, a switching valve 473, and a switching valve 474.

The switching valve 471 may be interposed in the refrigerant flow path 425. The switching valve 472 may be interposed in the refrigerant flow path 427. The switching valve 471 and the switching valve 472 may each operate in conjunction with a vehicle-compartment air conditioner that air-conditions a vehicle compartment of the vehicle 10. For example, when the vehicle-compartment air conditioner is in an on state, the switching valve 471 and the switching valve 472 may each be brought into an open state, causing the refrigerant 28 to circulate through the evaporator 38. Meanwhile, when the vehicle-compartment air conditioner is in an off state, the switching valve 471 and the switching valve 472 may each be brought into a closed state, preventing the refrigerant 28 from circulating through the evaporator 38.

The switching valve 473 may be interposed in the refrigerant flow path 423. The switching valve 474 may be interposed in the refrigerant flow path 4210. In the normal situation where hydrogen sulfide is not generated, the switching valve 473 and the switching valve 474 may each be brought into the closed state, preventing the refrigerant 28 from being supplied to the chiller 39. Upon the generation of hydrogen sulfide, the switching valve 473 and the switching valve 474 may each be brought into the open state, causing the refrigerant 28 to be supplied to the chiller 39.

An exemplary channel of the refrigerant flow passage 42 through which the refrigerant 28 is to circulate is as follows.

In the present example embodiment, when the vehicle-compartment air conditioner is in the on state, the switching valve 471 and the switching valve 472 may each be brought into the open state. The refrigerant 28 may be compressed by the compressor 45 and then transferred to the refrigerant flow path 426. The refrigerant 28 condensed by dissipating heat with the condenser 37 may be transferred to the expansion valve 46 via the refrigerant flow path 429. The refrigerant 28 expanded by the expansion valve 46 may be transferred to the evaporator 38 via the refrigerant flow path 4210, the switching valve 472, and the refrigerant flow path 427. The refrigerant 28 having evaporated by receiving heat at the evaporator 38 may return to the compressor 45 via the refrigerant flow path 425, the switching valve 471, the refrigerant flow path 422, and the refrigerant flow path 421.

A part of the refrigerant 28 expanded by the expansion valve 46 may be transferred to the chiller 39 via the refrigerant flow path 4210, the switching valve 474, and the refrigerant flow path 428. The refrigerant 28 having cooled the cooling water 29 of the cooling water circuit 34 at the chiller 39 may return to the compressor 45 via the refrigerant flow path 424, the switching valve 473, the refrigerant flow path 423, the refrigerant flow path 422, and the refrigerant flow path 421.

An exemplary flow of the cooling water 29 through the cooling water flow passage 43 in the situation where hydrogen sulfide has been generated is as follows. In this case, the three-way valve 481 may switch the flow direction of the cooling water 29 to cause the cooling water 29 to flow from the cooling water flow path 433 into the cooling water flow path 432. Further, the three-way valve 482 may switch the flow direction of the cooling water 29 to cause the cooling water 29 to flow from the cooling water flow path 437 into the cooling water flow path 438. At this time, the fluid pump 49 may be operated.

For example, the cooling water 29 cooled by the refrigeration cycle 36 at the chiller 39 may first flow into the battery 40 via the cooling water flow path 436, the cooling water flow path 437, the three-way valve 482, and the cooling water flow path 438. The cooling water 29 having cooled the battery 40 by circulating through the separator 31 illustrated in FIG. 4B may return to the chiller 39 via the fluid pump 49, the cooling water flow path 433, the three-way valve 481, the cooling water flow path 432, and the cooling water flow path 431.

Referring to FIG. 4B, the cooling water 29 may circulate through the separator 31 inside the battery 40. This generates condensation on a surface of the separator 31 and dissolves hydrogen sulfide in resultant condensed water to thereby detoxify hydrogen sulfide, upon the generation of hydrogen sulfide from the battery cells 22.

FIG. 5A is a block diagram illustrating the exemplary operation of the battery detoxification apparatus 20 including the cooling water 29 cooled by the radiator 41 as the cooling medium 33 in the normal situation where hydrogen sulfide is not generated. FIG. 5B is a cross-sectional view of the battery cells 22 and the separator 31.

Referring to FIG. 5A, the switching valve 471 and the switching valve 472 of the refrigeration cycle 36 may each be in the open state, and the switching valve 473 and the switching valve 474 of the refrigeration cycle 36 may each be in the closed state. In the cooling water circuit 34, the three-way valve 481 may switch the flow direction of the cooling water 29 to cause the cooling water 29 to flow from the cooling water flow path 434 into the cooling water flow path 433. The three-way valve 482 may switch the flow direction of the cooling water 29 to cause the cooling water 29 to flow from the cooling water flow path 438 into the cooling water flow path 439. At this time, the fluid pump 49 may be operated.

The exemplary operation of the battery detoxification apparatus 20 of which the respective valves have performed the above-described switching will now be described.

In the refrigeration cycle 36, the refrigerant 28 may sequentially circulate through the compressor 45, the refrigerant flow path 426, the condenser 37, the refrigerant flow path 429, the expansion valve 46, the refrigerant flow path 4210, the switching valve 472, the refrigerant flow path 427, the evaporator 38, the switching valve 471, the refrigerant flow path 425, the refrigerant flow path 422, the refrigerant flow path 421, and the compressor 45. This cools the vehicle compartment of the vehicle 10. The exemplary operation of the refrigeration cycle 36 may be similar to the operation as described with reference to FIG. 4A.

In the cooling water circuit 34, the cooling water 29 may sequentially circulate through the battery 40, the cooling water flow path 438, the three-way valve 482, the cooling water flow path 439, the cooling water flow path 4310, the radiator 41, the cooling water flow path 435, the cooling water flow path 434, the three-way valve 481, the cooling water flow path 433, the fluid pump 49, and the battery 40. This allows the cooling water 29 to dissipate heat at the radiator 41 and absorb heat corresponding to a temperature of the battery 40, enabling cooling of the battery 40.

Referring to FIG. 5B, the cooling water 29 cooled by the radiator 41 may circulate through the separator 31 inside the battery 40. This enables effective cooling of the battery cell 221 and the battery cell 222.

FIG. 6A is a block diagram illustrating the exemplary operation of the battery detoxification apparatus 20 including the cooling water 29 cooled by the chiller 39 as the cooling medium 33 in the normal situation where hydrogen sulfide is not generated. FIG. 6B is a cross-sectional view of the battery cells 22 and the separator 31.

Referring to FIG. 6A, the switching valve 471 and the switching valve 472 of the refrigeration cycle 36 as well as the switching valve 473 and the switching valve 474 of the refrigeration cycle 36 may each be in the open state. In the cooling water circuit 34, the three-way valve 481 may switch the flow direction of the cooling water 29 to cause the cooling water 29 to flow from the cooling water flow path 433 into the cooling water flow path 432. The three-way valve 482 may switch the flow direction of the cooling water 29 to cause the cooling water 29 to flow from the cooling water flow path 437 into the cooling water flow path 438.

The exemplary operation of the battery detoxification apparatus 20 of which the respective valves have performed the above-described switching will now be described.

In the refrigeration cycle 36, the refrigerant 28 may sequentially circulate through the compressor 45, the refrigerant flow path 426, the condenser 37, the refrigerant flow path 429, the expansion valve 46, the refrigerant flow path 4210, the switching valve 472, the refrigerant flow path 427, the evaporator 38, the switching valve 471, the refrigerant flow path 425, the refrigerant flow path 422, the refrigerant flow path 421, and the compressor 45. This cools the vehicle compartment of the vehicle 10. The exemplary operation of the refrigeration cycle 36 may be similar to the operation as described with reference to FIG. 4A.

In the refrigeration cycle 36, a part of the refrigerant 28 having passed through the expansion valve 46 may circulate through the refrigerant flow path 4210, the switching valve 474, the refrigerant flow path 428, the chiller 39, the refrigerant flow path 424, the refrigerant flow path 423, the switching valve 473, the refrigerant flow path 422, and the refrigerant flow path 421.

In the cooling water circuit 34, the cooling water 29 may sequentially circulate through the chiller 39, the cooling water flow path 436, the cooling water flow path 437, the three-way valve 482, the cooling water flow path 438, the battery 40, the fluid pump 49, the cooling water flow path 433, the three-way valve 481, the cooling water flow path 432, the cooling water flow path 431, and the chiller 39. This allows the cooling water 29 to be cooled by the refrigerant 28 of the refrigeration cycle 36 at the chiller 39 to thereby cool the battery cells 22 in the battery 40.

Referring to FIG. 6B, the cooling water 29 cooled by the chiller 39 may circulate through the separator 31 inside the battery 40. This enables effective cooling of the battery cell 221 and the battery cell 222.

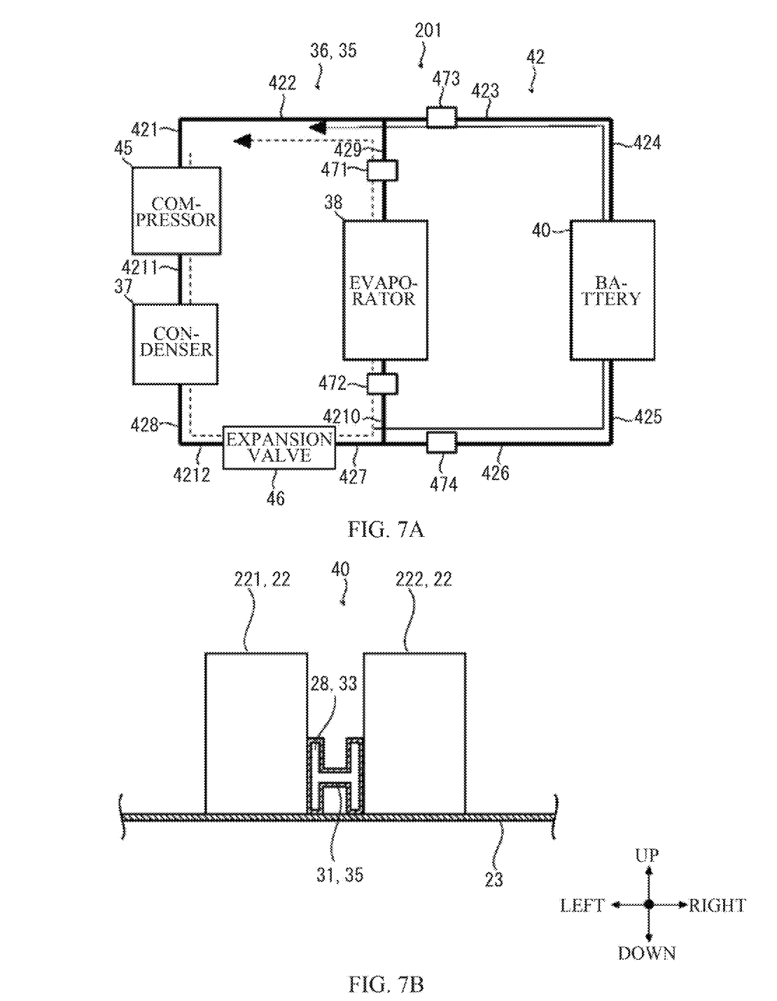

A battery detoxification apparatus 201 having an exemplary configuration in which the battery 40 is cooled with the refrigeration cycle 36 will be described with reference to FIGS. 7A to 9B.

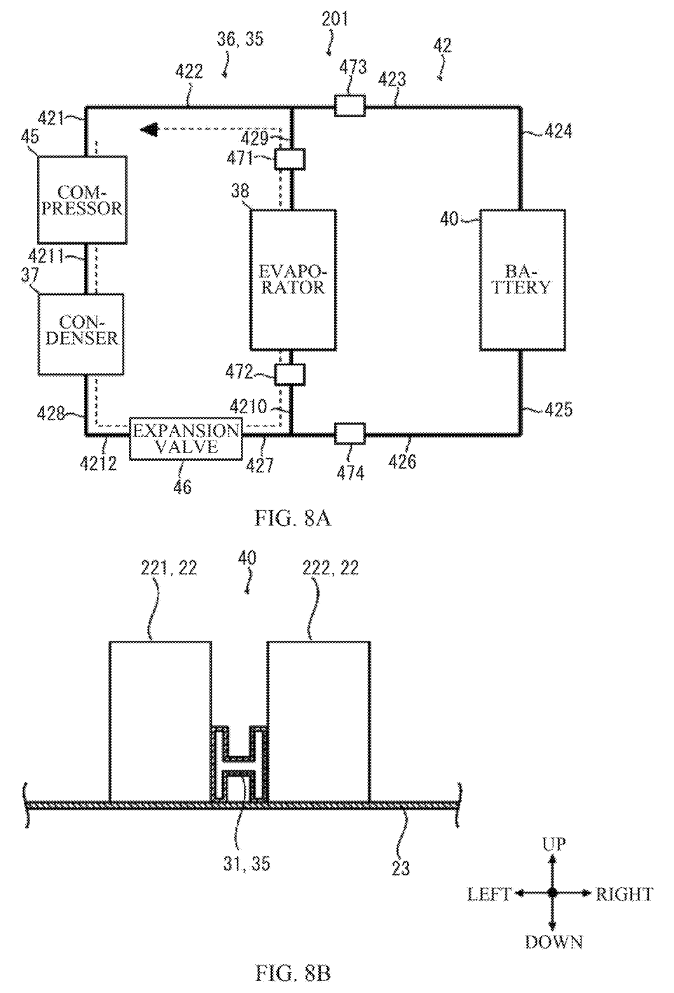

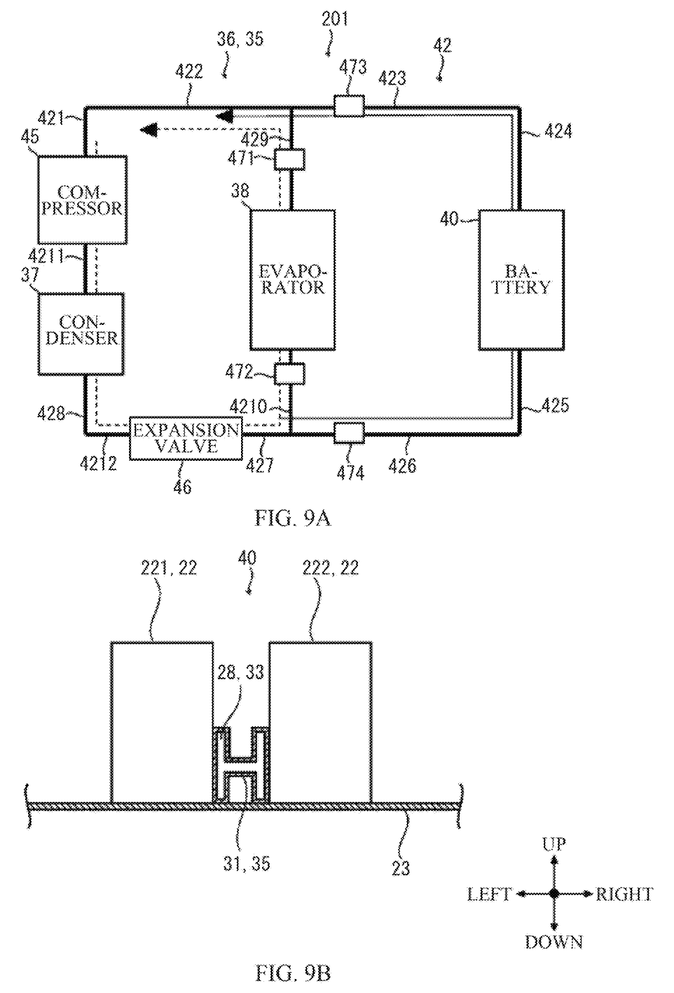

FIGS. 7A and 7B each illustrate an exemplary configuration and operation of the battery detoxification apparatus 201 in the situation where hydrogen sulfide has been generated inside the battery 40. FIGS. 8A and 8B each illustrate an exemplary configuration and operation of the battery detoxification apparatus 201 in which the battery 40 is not cooled in the normal situation where hydrogen sulfide is not generated inside the battery 40. FIGS. 9A and 9B each illustrate an exemplary configuration and operation of the battery detoxification apparatus 201 in which the battery 40 is cooled with the refrigeration cycle 36 in the normal situation where hydrogen sulfide is not generated inside the battery 40.

FIG. 7A is a block diagram illustrating the exemplary configuration and operation of the battery detoxification apparatus 201 in the situation where hydrogen sulfide has been generated inside the battery 40. FIG. 7B is a cross-sectional view of the battery cells 22 and the separator 31 in the situation where hydrogen sulfide has been generated inside the battery 40.

Referring to FIG. 7A, the battery detoxification apparatus 201 may include the compressor 45, the condenser 37, the expansion valve 46, the evaporator 38, and the battery 40.

The refrigerant flow passage 42 may be configured to couple the respective devices of the battery detoxification apparatus 201 to each other. The refrigerant flow passage 42 may include the refrigerant flow path 421, the refrigerant flow path 422, the refrigerant flow path 423, the refrigerant flow path 424, the refrigerant flow path 425, the refrigerant flow path 426, the refrigerant flow path 427, the refrigerant flow path 428, the refrigerant flow path 429, the refrigerant flow path 4210, a refrigerant flow path 4211, and a refrigerant flow path 4212. The refrigerant flow path 421, the refrigerant flow path 422, the refrigerant flow path 423, and the refrigerant flow path 424 may form a channel that couples the compressor 45 to the battery 40. The refrigerant flow path 429 may form a channel that couples the evaporator 38 to a coupling part that couples the refrigerant flow path 422 to the refrigerant flow path 423. The refrigerant flow path 4211 may form a channel that couples the compressor 45 to the condenser 37. The refrigerant flow path 428 and the refrigerant flow path 4212 may form a channel that couples the condenser 37 to the expansion valve 46. The refrigerant flow path 427, the refrigerant flow path 426, and the refrigerant flow path 425 may form a channel that couples the expansion valve 46 to the battery 40. The refrigerant flow path 4210 may form a channel that couples the evaporator 38 to a coupling part that couples the refrigerant flow path 427 to the refrigerant flow path 426.

In the refrigerant flow passage 42 of the battery detoxification apparatus 201 may be disposed the switching valve 471, the switching valve 472, the switching valve 473, and the switching valve 474. In some embodiments, the switching valve 471 may be interposed in the refrigerant flow path 429, and the switching valve 472 may be interposed in the refrigerant flow path 4210. The switching valve 471 and the switching valve 472 may each be brought into the open state upon turning on the vehicle-compartment air conditioner that air-conditions the vehicle compartment of the vehicle 10. The switching valve 473 may be interposed in the refrigerant flow path 423, and the switching valve 474 may be interposed in the refrigerant flow path 426. The switching valve 473 and the switching valve 474 may each be brought into the open state to cool the battery 40.

The switching valve 473 and the switching valve 474 may each be brought into the open state upon the generation of hydrogen sulfide inside the battery 40. Meanwhile, the switching valve 471 and the switching valve 472 may each be brought into the open state upon turning on the vehicle-compartment air conditioner.

In the refrigeration cycle 36, the refrigerant 28 may sequentially circulate through the compressor 45, the refrigerant flow path 4211, the condenser 37, the refrigerant flow path 428, the refrigerant flow path 4212, the expansion valve 46, the refrigerant flow path 427, the refrigerant flow path 4210, the switching valve 472, the evaporator 38, the refrigerant flow path 429, the switching valve 471, the refrigerant flow path 422, the refrigerant flow path 421, and the compressor 45.

A part of the refrigerant 28 having passed through the expansion valve 46 may circulate through the refrigerant flow path 427, the switching valve 474, the refrigerant flow path 426, the refrigerant flow path 425, the battery 40, the refrigerant flow path 424, the refrigerant flow path 423, the switching valve 473, and the refrigerant flow path 422.

Referring to FIG. 7B, the refrigerant 28 may circulate through the separator 31 inside the battery 40. This generates condensation on the surface of the separator 31 and dissolves hydrogen sulfide in resultant condensed water to thereby detoxify hydrogen sulfide, upon the generation of hydrogen sulfide from the battery cells 22.

FIG. 8A is a block diagram illustrating the exemplary configuration and operation of the battery detoxification apparatus 201 in which the battery 40 is not cooled in the normal situation where hydrogen sulfide is not generated inside the battery 40. FIG. 8B is a cross-sectional view of the battery cells 22 and the separator 31 in the case of not cooling the battery 40 in the normal situation where hydrogen sulfide is not generated inside the battery 40.

Referring to FIG. 8A, the switching valve 471 and the switching valve 472 may each be brought into the open state to air-condition the vehicle compartment of the vehicle 10. The switching valve 473 and the switching valve 474 may each be brought into the closed state because of not cooling the battery 40.

In the battery detoxification apparatus 201, the refrigerant 28 may sequentially circulate through the compressor 45, the refrigerant flow path 4211, the condenser 37, the refrigerant flow path 428, the refrigerant flow path 4212, the expansion valve 46, the refrigerant flow path 427, the refrigerant flow path 4210, the switching valve 472, the evaporator 38, the refrigerant flow path 429, the switching valve 471, the refrigerant flow path 422, the refrigerant flow path 421, and the compressor 45.

Meanwhile, the refrigerant 28 may not be supplied to a side of the battery 40 because the switching valve 473 and the switching valve 474 are each in the closed state. The refrigerant 28 thus may not circulate through the separator 31.

Because the refrigerant 28 does not circulate through the separator 31 as illustrated in FIG. 8B, the separator 31 may not cool the battery cell 221 and the battery cell 222.

FIG. 9A is a block diagram illustrating the exemplary configuration and operation of the battery detoxification apparatus 201 in which the battery 40 is cooled in the normal situation where hydrogen sulfide is not generated inside the battery 40. FIG. 9B is a cross-sectional view of the battery cells 22 and the separator 31 in the case of cooling the battery 40 in the normal situation where hydrogen sulfide is not generated inside the battery 40.

Referring to FIG. 9A, the switching valve 471 and the switching valve 472 may each be brought into the open state to air-condition the vehicle compartment of the vehicle 10. The switching valve 473 and the switching valve 474 may each be brought into the open state to cool the battery 40.

In the battery detoxification apparatus 201, the refrigerant 28 may sequentially circulate through the compressor 45, the refrigerant flow path 4211, the condenser 37, the refrigerant flow path 428, the refrigerant flow path 4212, the expansion valve 46, the refrigerant flow path 427, the refrigerant flow path 4210, the switching valve 472, the evaporator 38, the refrigerant flow path 429, the switching valve 471, the refrigerant flow path 422, the refrigerant flow path 421, and the compressor 45.

A part of the refrigerant 28 having passed through the expansion valve 46 may circulate through the refrigerant flow path 427, the switching valve 474, the refrigerant flow path 426, the refrigerant flow path 425, the battery 40, the refrigerant flow path 424, the refrigerant flow path 423, the switching valve 473, and the refrigerant flow path 422.

Referring to FIG. 9B, the refrigerant 28 may circulate through the separator 31 inside the battery 40. This cools the battery cell 221 and the battery cell 222.

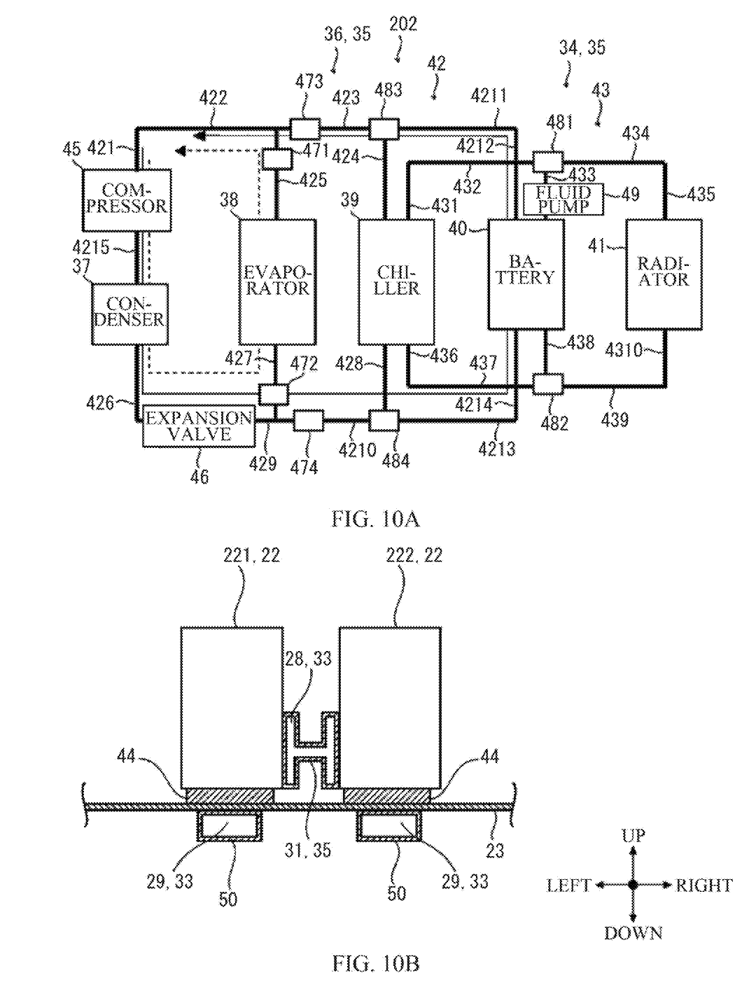

A battery detoxification apparatus 202 having an exemplary configuration in which the battery 40 is cooled with the cooling water circuit 34 and the refrigeration cycle 36 will be described with reference to FIGS. 10A to 12B.

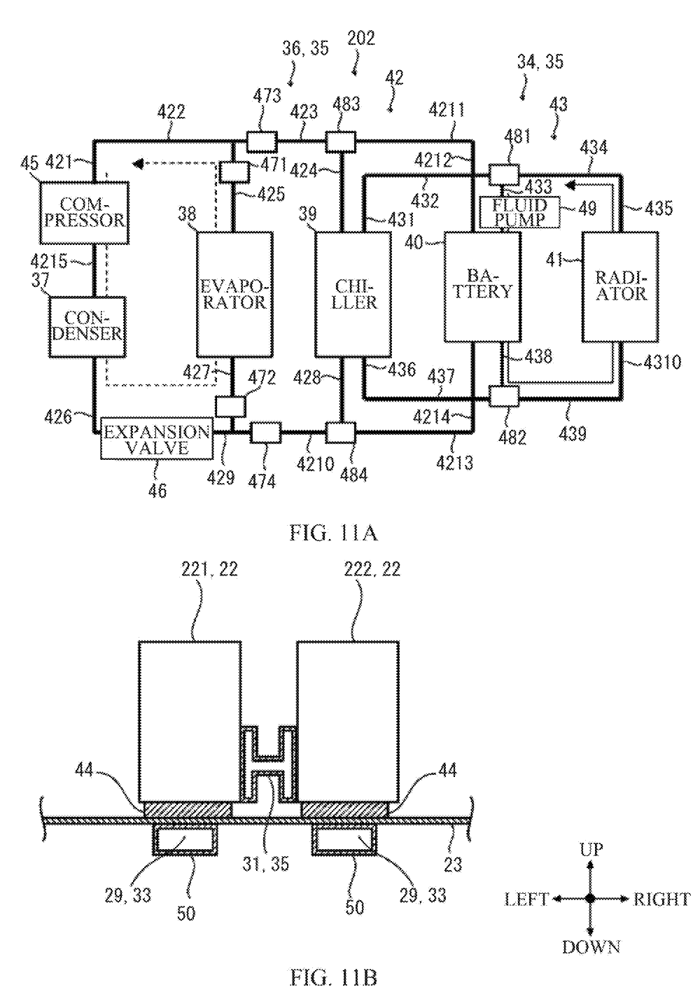

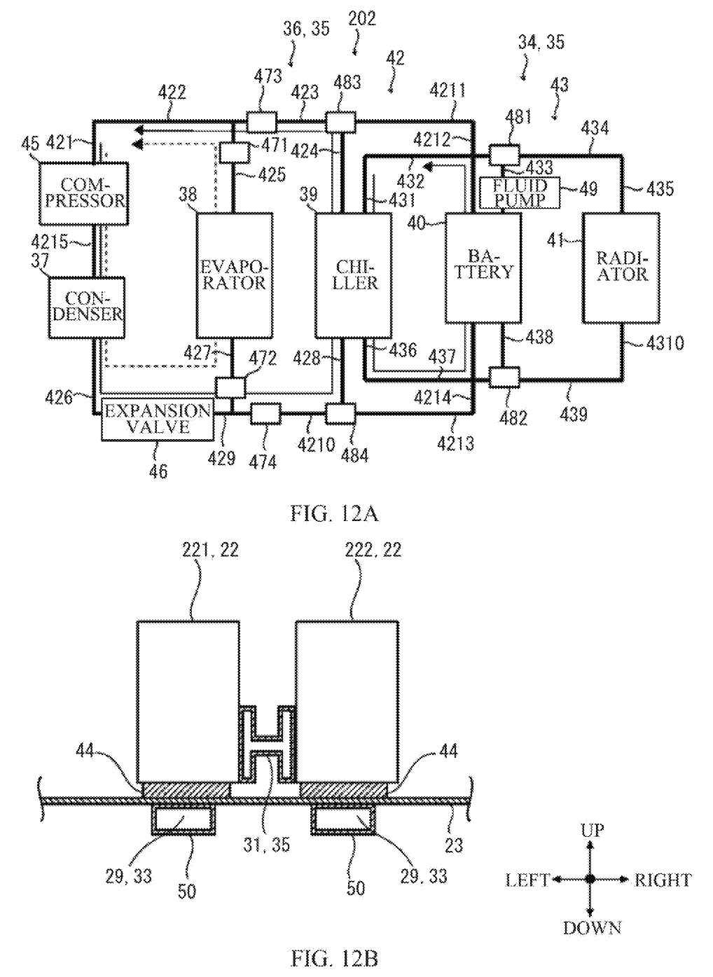

FIGS. 10A and 10B each illustrate an exemplary configuration and operation of the battery detoxification apparatus 202 in the situation where hydrogen sulfide has been generated inside the battery 40. FIGS. 11A and 11B each illustrate an exemplary configuration and operation of the battery detoxification apparatus 202 in which the refrigeration cycle 36 is operated and the battery 40 is cooled with the cooling water flow passage 43 in the normal situation where hydrogen sulfide is not generated inside the battery 40. FIGS. 12A and 12B each illustrate an exemplary configuration and operation of the battery detoxification apparatus 202 in which the refrigeration cycle 36 is operated and the battery 40 is cooled with the chiller 39 in the normal situation where hydrogen sulfide is not generated inside the battery 40.

The exemplary configuration of the battery detoxification apparatus 202 will be described with reference to FIG. 10A. The battery detoxification apparatus 202 may include the refrigeration cycle 36 and the cooling water circuit 34 as the medium cooler 35.

The refrigeration cycle 36 may include devices such as the compressor 45, the condenser 37, the expansion valve 46, or the evaporator 38. To the refrigeration cycle 36 may further be coupled the chiller 39 and the battery 40.

The respective devices of the refrigeration cycle 36 may be coupled to each other by the refrigerant flow passage 42. In some embodiments, the refrigerant flow path 421, the refrigerant flow path 422, the refrigerant flow path 423, the refrigerant flow path 4211, and the refrigerant flow path 4212 may form a channel that couples the compressor 45 to the battery 40. The refrigerant flow path 425 may form a channel that couples the evaporator 38 to a coupling part that couples the refrigerant flow path 422 to the refrigerant flow path 423. The refrigerant flow path 424 may form a channel that couples the chiller 39 to a coupling part that couples the refrigerant flow path 423 to the refrigerant flow path 4211. A refrigerant flow path 4215 may form a channel that couples the compressor 45 to the condenser 37. The refrigerant flow path 426 may form a channel that couples the condenser 37 to the expansion valve 46. The refrigerant flow path 429, the refrigerant flow path 4210, a refrigerant flow path 4213, and a refrigerant flow path 4214 may form a channel that couples the expansion valve 46 to the battery 40. The refrigerant flow path 427 may form a channel that couples the evaporator 38 to an intermediate part of the refrigerant flow path 429. The refrigerant flow path 428 may form a channel that couples the chiller 39 to a coupling part that couples the refrigerant flow path 4210 to the refrigerant flow path 4213.

In the refrigerant flow passage 42 may be disposed the switching valve 471, the switching valve 472, the switching valve 473, and the switching valve 474. The switching valve 471 may be interposed in the refrigerant flow path 425, the switching valve 472 may be interposed in the refrigerant flow path 427, the switching valve 473 may be interposed in the refrigerant flow path 423, and the switching valve 474 may be interposed in the refrigerant flow path 4210. In the refrigerant flow passage 42 may further be interposed a three-way valve 483 and a three-way valve 484. The three-way valve 483 may be disposed at a coupling part that couples the refrigerant flow path 423, the refrigerant flow path 4211, and the refrigerant flow path 424 to each other. The three-way valve 484 may be disposed at a coupling part that couples the refrigerant flow path 4210, the refrigerant flow path 428, and the refrigerant flow path 4213 to each other.

The cooling water circuit 34 may cause the cooling water 29 to circulate among the fluid pump 49, the radiator 41, the battery 40, and the chiller 39.

The respective devices of the cooling water circuit 34 may be coupled to each other by the cooling water flow passage 43. In some embodiments, the cooling water flow path 431, the cooling water flow path 432, the cooling water flow path 434, and the cooling water flow path 435 may form a channel that couples the chiller 39 to the radiator 41. The cooling water flow path 433 may form a channel that couples the battery 40 to a coupling part that couples the cooling water flow path 432 to the cooling water flow path 434. The cooling water flow path 436, the cooling water flow path 437, the cooling water flow path 439, and the cooling water flow path 4310 may form a channel that couples the chiller 39 to the radiator 41. The cooling water flow path 438 may form a channel that couples the battery 40 to a coupling part that couples the cooling water flow path 437 to the cooling water flow path 439. The fluid pump 49 may further be interposed in the cooling water flow path 433.

In the cooling water flow passage 43 may be interposed the three-way valve 481 and the three-way valve 482. The three-way valve 481 may be disposed at a coupling part that couples the cooling water flow path 432, the cooling water flow path 433, and the cooling water flow path 434 to each other. The three-way valve 482 may be disposed at a coupling part that couples the cooling water flow path 437, the cooling water flow path 438, and the cooling water flow path 439 to each other.

Exemplary states of the respective valves in the situation where hydrogen sulfide has been generated inside the battery 40 are as follows. The switching valve 471 and the switching valve 472 may each be brought into the open state upon turning on the vehicle-compartment air conditioner. The switching valve 473 and the switching valve 474 may each be brought into the open state. The three-way valve 483 of the cooling water circuit 34 may switch a flow direction of the refrigerant 28 to cause the refrigerant 28 to flow from the refrigerant flow path 4211 into the refrigerant flow path 423. The three-way valve 484 may switch the flow direction of the refrigerant 28 to cause the refrigerant 28 to flow from the refrigerant flow path 4210 into the refrigerant flow path 4213. At this time, the fluid pump 49 may not be operated.

In the refrigeration cycle 36, the refrigerant 28 may sequentially circulate through the compressor 45, the refrigerant flow path 4215, the condenser 37, the refrigerant flow path 426, the expansion valve 46, the refrigerant flow path 429, the switching valve 472, the refrigerant flow path 427, the evaporator 38, the refrigerant flow path 425, the switching valve 471, the refrigerant flow path 422, the refrigerant flow path 421, and the compressor 45.

In the refrigeration cycle 36, a part of the refrigerant 28 may be used to cool the battery 40. In some embodiments, the part of the refrigerant 28 may sequentially circulate through the compressor 45, the refrigerant flow path 4215, the condenser 37, the refrigerant flow path 426, the expansion valve 46, the refrigerant flow path 429, the switching valve 474, the refrigerant flow path 4210, the three-way valve 484, the refrigerant flow path 4213, the refrigerant flow path 4214, the battery 40, the refrigerant flow path 4212, the refrigerant flow path 4211, the three-way valve 483, the refrigerant flow path 423, the switching valve 473, the refrigerant flow path 422, the refrigerant flow path 421, and the compressor 45.

FIG. 10B is a cross-sectional view of the battery cells 22, a water cooler 50, and the separator 31 serving as the medium cooler 35. In this example illustrated in FIG. 10B, respective channels through which the cooling medium 33 is to flow may be the separator 31 and the water cooler 50. The separator 31 may be a channel through which the refrigerant 28 is to flow, and the water cooler 50 may be a channel through which the cooling water 29 is to flow.

A heat transfer sheet 44 may be disposed between a lower surface of the battery cell 221 and an upper surface of the battery pack housing 23. Similarly, the heat transfer sheet 44 may also be disposed between a lower surface of the battery cell 222 and an upper surface of the battery pack housing 23. The heat transfer sheet 44 may include any highly thermally-conductive material such as metal.

The water cooler 50 may be disposed on the lower surface of the battery pack housing 23 at a position below each of the battery cell 221 and the battery cell 222. The water cooler 50 may be a pipeline having a rectangular parallelepiped shape and disposed to be closely attached to the lower surface of the battery pack housing 23. In other words, the water cooler 50 may be disposed outside the battery pack housing 23. The water cooler 50 may be thermally coupled to each of the battery cell 221 and the battery cell 222 via the battery pack housing 23 and the heat transfer sheet 44. The water cooler 50 may have a first end coupled to the cooling water flow path 433 illustrated in FIG. 10A and a second end coupled to the cooling water flow path 438 illustrated in FIG. 10A.

The refrigerant 28 may circulate through the separator 31 inside the battery 40. This generates condensation on the surface of the separator 31 and dissolves hydrogen sulfide in resultant condensed water to thereby detoxify hydrogen sulfide, upon the generation of hydrogen sulfide from the battery cells 22.

FIG. 11A illustrates the exemplary configuration and operation of the battery detoxification apparatus 202 in which the refrigeration cycle 36 is operated and the battery 40 is cooled with the cooling water circuit 34 in the normal situation where hydrogen sulfide is not generated inside the battery 40. FIG. 11B is a cross-sectional view of the battery cells 22, the water cooler 50, and the separator 31 having the configuration in which the battery cells 22 is cooled in the normal situation where hydrogen sulfide is not generated inside the battery 40.

Exemplary states of the respective valves will be described with reference to FIG. 11A. The switching valve 471 and the switching valve 472 may each be brought into the open state upon turning on the vehicle-compartment air conditioner. The switching valve 473 and the switching valve 474 may each be brought into the closed state. The three-way valve 483 may be brought into any state such as the open state or the closed state because the refrigerant 28 does not flow into the three-way valve 483. Similarly, the three-way valve 484 may be brought into any state such as the open state or the closed state because the refrigerant 28 does not flow into the three-way valve 484. The three-way valve 481 of the cooling water circuit 34 may switch the flow direction of the cooling water 29 to cause the cooling water 29 to flow from the cooling water flow path 434 into the cooling water flow path 433. The three-way valve 482 may switch the flow direction of the cooling water 29 to cause the cooling water 29 to flow from the cooling water flow path 438 into the cooling water flow path 439. At this time, the fluid pump 49 may be operated.

In the refrigeration cycle 36, the refrigerant 28 may sequentially circulate through the compressor 45, the refrigerant flow path 4215, the condenser 37, the refrigerant flow path 426, the expansion valve 46, the refrigerant flow path 429, the switching valve 472, the refrigerant flow path 427, the evaporator 38, the refrigerant flow path 425, the switching valve 471, the refrigerant flow path 422, the refrigerant flow path 421, and the compressor 45.

In the cooling water flow passage 43, the cooling water 29 may sequentially circulate through the fluid pump 49, the cooling water flow path 433, the battery 40, the cooling water flow path 438, the three-way valve 482, the cooling water flow path 439, the cooling water flow path 4310, the radiator 41, the cooling water flow path 435, the cooling water flow path 434, the three-way valve 481, the cooling water flow path 433, and the fluid pump 49.

Referring to FIG. 11B, the cooling water 29 cooled by the radiator 41 may circulate through the water cooler 50. The cooling water 29 circulating through the water cooler 50 thus cools the battery cell 221 and the battery cell 222 via the heat transfer sheet 44.

FIG. 12A is a block diagram illustrating the exemplary configuration and operation of the battery detoxification apparatus 202 in which the refrigeration cycle 36 is operated and the battery 40 is cooled with the chiller 39 in the normal situation where hydrogen sulfide is not generated inside the battery 40. FIG. 12B is a cross-sectional view of the battery cells 22, the water cooler 50, and the separator 31 having the configuration in which the battery cells 22 is cooled in the normal situation where hydrogen sulfide is not generated inside the battery 40.

Exemplary states of the respective valves will be described with reference to FIG. 12A. The switching valve 471 and the switching valve 472 may each be brought into the open state upon turning on the vehicle-compartment air conditioner. The switching valve 473 and the switching valve 474 may each be brought into the open state. The three-way valve 483 may switch the flow direction of the refrigerant 28 to cause the refrigerant 28 to flow from the refrigerant flow path 424 into the refrigerant flow path 423. The three-way valve 484 may switch the flow direction of the refrigerant 28 to cause the refrigerant 28 to flow from the refrigerant flow path 4210 into the refrigerant flow path 428. Any method of switching the flow direction of the cooling water 29 with each of the three-way valve 481 and the three-way valve 482 of the cooling water circuit 34 may be employed because the cooling water 29 does not circulate through each of the three-way valve 481 and the three-way valve 482. At this time, the fluid pump 49 may not be operated.

In the refrigeration cycle 36, the refrigerant 28 may sequentially circulate through the compressor 45, the refrigerant flow path 4215, the condenser 37, the refrigerant flow path 426, the expansion valve 46, the refrigerant flow path 429, the switching valve 472, the refrigerant flow path 427, the evaporator 38, the refrigerant flow path 425, the switching valve 471, the refrigerant flow path 422, the refrigerant flow path 421, and the compressor 45.

In the refrigeration cycle 36, a part of the refrigerant 28 may sequentially circulate through the compressor 45, the refrigerant flow path 4215, the condenser 37, the refrigerant flow path 426, the expansion valve 46, the refrigerant flow path 429, the switching valve 474, the refrigerant flow path 4210, the three-way valve 484, the refrigerant flow path 428, the chiller 39, the refrigerant flow path 424, the three-way valve 483, the refrigerant flow path 423, the switching valve 473, the refrigerant flow path 422, the refrigerant flow path 421, and the compressor 45.

In the cooling water circuit 34, the cooling water 29 may sequentially circulate through the fluid pump 49, the cooling water flow path 433, the three-way valve 481, the cooling water flow path 432, the cooling water flow path 431, the chiller 39, the cooling water flow path 436, the cooling water flow path 437, the three-way valve 482, the cooling water flow path 438, the battery 40, the cooling water flow path 433, and the fluid pump 49. This helps to cool the cooling water 29 of the cooling water circuit 34 with the refrigerant 28 of the refrigeration cycle 36 at the chiller 39. The cooled cooling water 29 may be transferred to the battery 40.

Referring to FIG. 12B, the cooling water 29 cooled by the chiller 39 may circulate through the water cooler 50. The cooling water 29 circulating through the water cooler 50 thus cools the battery cell 221 and the battery cell 222 via the heat transfer sheet 44.

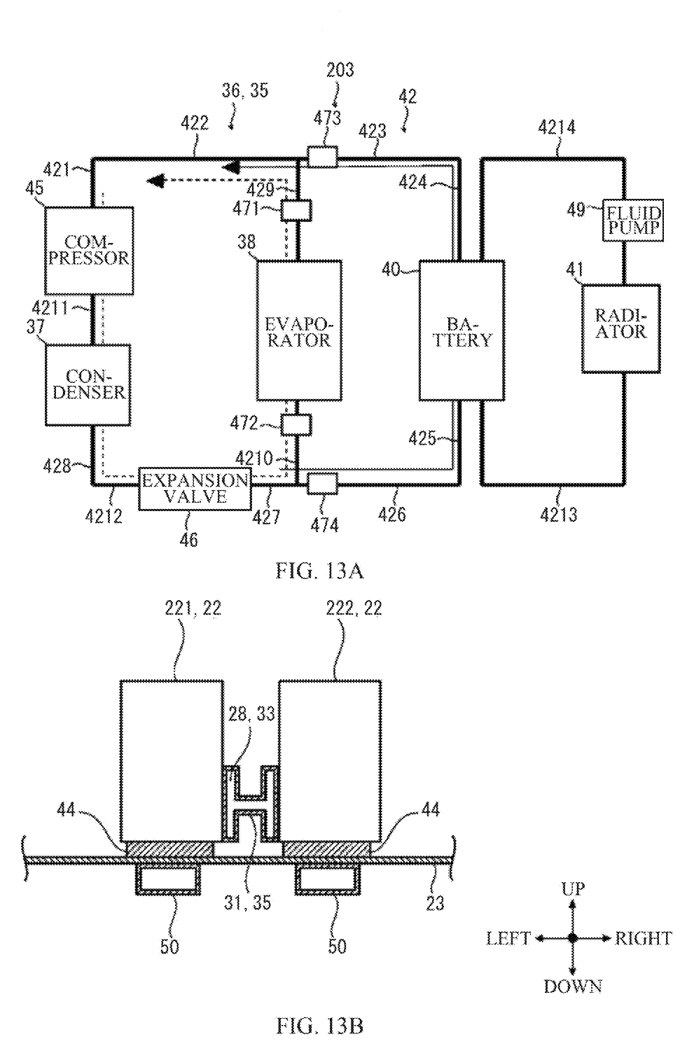

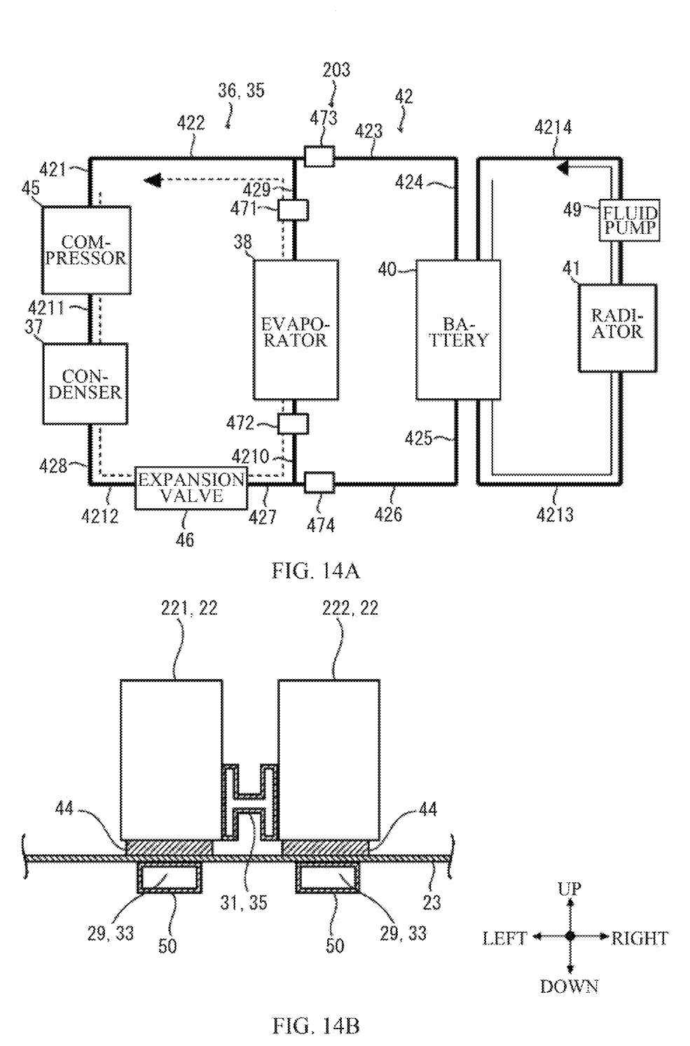

A battery detoxification apparatus 203 having an exemplary configuration in which the battery 40 is cooled with the refrigeration cycle 36 and the radiator 41 will be described with reference to FIGS. 13A to 14B. FIGS. 13A and 13B each illustrate an exemplary configuration and operation of the battery detoxification apparatus 203 in the situation where hydrogen sulfide has been generated inside the battery 40. FIGS. 14A and 14B each illustrate an exemplary operation of the battery detoxification apparatus 203 performed in the normal situation where hydrogen sulfide is not generated inside the battery 40.

The exemplary configuration of the battery detoxification apparatus 203 illustrated in FIG. 13A may be substantially similar to the configuration of the battery detoxification apparatus 201 illustrated in FIG. 7A. The battery detoxification apparatus 203 illustrated in FIG. 13A may have a configuration in which the battery detoxification apparatus 201 illustrated in FIG. 7A is combined with a part of cooling the battery 40 with the radiator 41. The radiator 41 may be coupled to the battery 40 via the refrigerant flow path 4213 and the refrigerant flow path 4214. In the refrigerant flow path 4214 may be interposed the fluid pump 49.

A cross-sectional configuration illustrated in FIG. 13B may be similar to the cross-sectional configuration described with reference to FIG. 10B.

The exemplary operation of the battery detoxification apparatus 203 in the situation where hydrogen sulfide has been generated inside the battery 40 will be described with reference to FIGS. 13A and 13B. FIG. 13A is a block diagram illustrating the exemplary operation of the battery detoxification apparatus 203 in the situation where hydrogen sulfide has been generated inside the battery 40. FIG. 13B is a cross-sectional view of the battery cells 22, the water cooler 50, and the separator 31 in the situation where hydrogen sulfide has been generated inside the battery 40.

Exemplary states of the respective valves in the situation where hydrogen sulfide has been generated inside the battery 40 will be described with reference to FIG. 13A. When the vehicle-compartment air conditioner is in the on state, the switching valve 471 and the switching valve 472 may each be brought into the open state. The switching valve 473 and the switching valve 474 may each be brought into the open state. At this time, the fluid pump 49 may not be operated.

In the refrigeration cycle 36, the refrigerant 28 may sequentially circulate through the compressor 45, the refrigerant flow path 4211, the condenser 37, the refrigerant flow path 428, the refrigerant flow path 4212, the expansion valve 46, the refrigerant flow path 427, the refrigerant flow path 4210, the switching valve 472, the evaporator 38, the refrigerant flow path 429, the switching valve 471, the refrigerant flow path 422, the refrigerant flow path 421, and the compressor 45.

A part of the refrigerant 28 having passed through the expansion valve 46 may circulate through the refrigerant flow path 427, the switching valve 474, the refrigerant flow path 426, the refrigerant flow path 425, the battery 40, the refrigerant flow path 424, the refrigerant flow path 423, the switching valve 473, and the refrigerant flow path 422.

Referring to FIG. 13B, the refrigerant 28 may circulate through the separator 31 inside the battery 40. This generates condensation on the surface of the separator 31 and dissolves hydrogen sulfide in resultant condensed water to thereby detoxify hydrogen sulfide, upon the generation of hydrogen sulfide from the battery cells 22.

The exemplary operation of the battery detoxification apparatus 203 performed in the normal situation where hydrogen sulfide is not generated inside the battery 40 will be described with reference to FIGS. 14A and 14B. FIG. 14A is a block diagram illustrating the exemplary operation of the battery detoxification apparatus 203 performed in the normal situation where hydrogen sulfide is not generated inside the battery 40. FIG. 14B is a cross-sectional view of the battery cells 22, the water cooler 50, and the separator 31 for the operation performed in the normal situation where hydrogen sulfide is not generated inside the battery 40.

Referring to FIG. 14A, the switching valve 471 and the switching valve 472 may each be brought into the open state when the vehicle-compartment air conditioner is in the on state. The switching valve 473 and the switching valve 474 may each be brought into the closed state. At this time, the fluid pump 49 may be operated.

In the refrigeration cycle 36, the refrigerant 28 may sequentially circulate through the compressor 45, the refrigerant flow path 4211, the condenser 37, the refrigerant flow path 428, the refrigerant flow path 4212, the expansion valve 46, the refrigerant flow path 427, the refrigerant flow path 4210, the switching valve 472, the evaporator 38, the refrigerant flow path 429, the switching valve 471, the refrigerant flow path 422, the refrigerant flow path 421, and the compressor 45.

The cooling water 29 pumped by the fluid pump 49 may sequentially circulate through the refrigerant flow path 4214, the battery 40, the refrigerant flow path 4213, the radiator 41, and the fluid pump 49.

Referring to FIG. 14B, circulating the cooling water 29 through the water cooler 50 helps to cool the battery cell 221 and the battery cell 222 via the battery pack housing 23 and the heat transfer sheet 44.

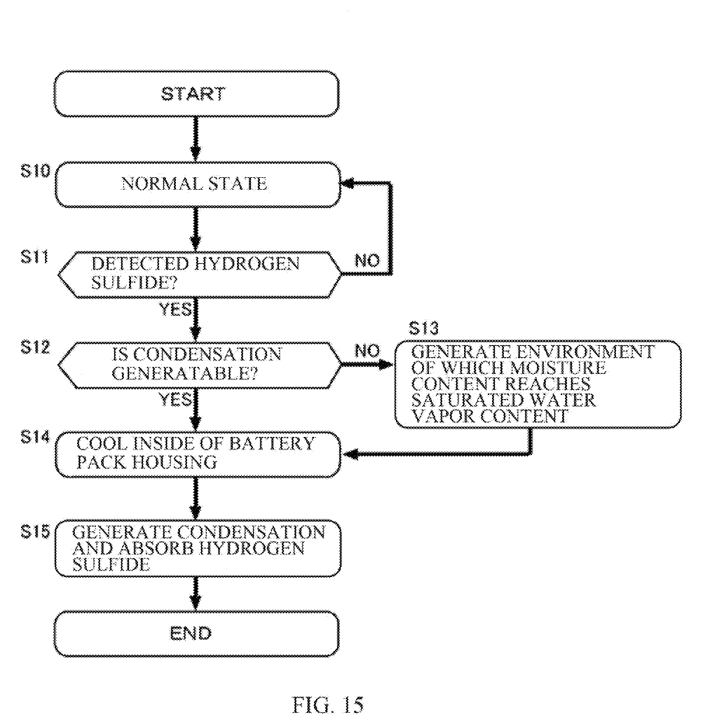

FIG. 15 is a flowchart illustrating an exemplary method of detoxifying hydrogen sulfide generated from the battery cells 22.

In step S10, the vehicle 10 may be determined to be in a normal state. For example, the vehicle 10 illustrated in FIG. 1 may be brought into a traveling state by driving the motor with electric power supplied from the battery pack 21 to rotate wheels of the vehicle 10.

In step S11, the calculation processor 24 may determine whether hydrogen sulfide has been detected. In some embodiments, the detector 25 illustrated in FIG. 1 may determine whether hydrogen sulfide has been generated from the battery cells 22. The detection of hydrogen sulfide inside the battery pack housing 23 may be made either directly or indirectly. In some embodiments where the detection is made directly, a hydrogen sulfide sensor serving as the detector 25 may be disposed inside the battery pack housing 23, and the calculation processor 24 may determine whether hydrogen sulfide has been detected, based on an output of the hydrogen sulfide sensor. In some embodiments where the detection is made indirectly, the detector 25 may be configured to detect data including the temperature of the battery cells 22, the deformation amount of the battery cells 22, and the contact of the vehicle 10. For example, if the temperature or the deformation amount of the battery cells 22 exceeds a threshold, the calculation processor 24 may determine that hydrogen sulfide has been generated.

If determining that hydrogen sulfide has been detected (step S11: YES), the calculation processor 24 may cause the flow to proceed to step S12.

If determining that hydrogen sulfide has not been detected (step S11: NO), the calculation processor 24 may cause the flow to proceed to step S10.

In step S12, the calculation processor 24 may determine whether condensation is generatable inside the battery pack housing 23. In some embodiments, the calculation processor 24 illustrated in FIG. 1 may measure data including a moisture content (i.e., an air moisture content) inside the battery pack housing 23, a temperature inside the battery pack housing 23, and a lower limit temperature of the cooling medium 33 in the medium circulator 30. In some embodiments, the moisture content inside the battery pack housing 23 may be calculated based on humidity inside the battery pack housing 23 measured by a hygrometer disposed inside the battery pack housing 23. In some embodiments, the temperature inside the battery pack housing 23 may be measured by a thermometer disposed inside the battery pack housing 23. In some embodiments, the lower limit temperature of the cooling medium 33 may be held by the calculation processor 24 in advance as performance of the battery detoxification apparatus 20. Thereafter, the calculation processor 24 may determine whether condensation is generatable by increasing the air moisture content inside the battery pack housing 23 to a saturated water vapor content, based on data including the moisture content inside the battery pack housing 23, the temperature inside the battery pack housing 23, and the lower limit temperature of the cooling medium 33 in the medium circulator 30.

If determining that condensation is generatable inside the battery pack housing 23 (step S12: YES), the calculation processor 24 may cause the flow to proceed to step S14.

If determining that condensation is not generatable inside the battery pack housing 23 (step S12: NO), the calculation processor 24 may cause the flow to proceed to step S13.

In step S13, the calculation processor 24 may generate an environment inside the battery pack housing 23 of which the moisture content reaches the saturated water vapor content. In some embodiments, the moisture content inside the battery pack housing 23 may be increased by introducing external air into the battery pack housing 23. In some embodiments, the moisture content inside the battery pack housing 23 may be increased by introducing internal air of the vehicle 10 into the battery pack housing 23. In some embodiments, the temperature of the cooling medium 33 may be set lower than an internal temperature of the battery pack housing 23. Execution of any of these operations helps to generate the environment inside the battery pack housing 23 of which the moisture content reaches the saturated water vapor content.

In step S14, the calculation processor 24 may cool the inside of the battery pack housing 23. In some embodiments, the calculation processor 24 may cool the inside of the battery pack housing 23 by any of the methods described with reference to FIGS. 4A, 7A, 10A, and 13A. In these methods, the cooling water 29 may be circulated through the separator 31 by controlling opening and closing of the respective valves and an operation of the fluid pump 49. This may lower an air temperature around the separator 31 inside the battery pack housing 23 to thereby increase the air moisture content around the separator 31 inside the battery pack housing 23 to the saturated water vapor content and generate condensation on the surface of the separator 31.

In step S15, condensed water may be generated on the surface of the separator 31 inside the battery pack housing 23, as illustrated in FIG. 4B, for example. The separator 31 having the H-shaped cross-section may gather condensed water in a recessed region formed by the upper part of the separator 31. Further, hydrogen sulfide having a larger specific gravity than air may be gatherable at the upper part of the separator 31. The hydrogen sulfide inside the battery pack housing 23 is thereby dissolved in the condensed water and detoxified.

In the following, technical ideas derived from the foregoing example embodiments will be described together with example effects thereof.

A battery detoxification apparatus according to at least one embodiment of the disclosure is to be applied to a vehicle. The battery detoxification apparatus includes a medium circulator, a medium cooler, a detector, and a calculation processor. The medium circulator is disposed between battery cells. The medium circulator is configured to allow a cooling medium to circulate therethrough. The battery cells include a sulfide. The medium cooler is configured to cool the cooling medium. The detector is configured to detect generation of hydrogen sulfide from the battery cells. Upon the detector detecting the generation of the hydrogen sulfide, the calculation processor is configured to circulate the cooling medium cooled by the medium cooler through the medium circulator. Such a configuration allows the cooled cooling medium to circulate through the medium circulator upon the detector detecting the generation of hydrogen sulfide from the solid-state battery. This helps to generate condensation on a surface of the medium circulator and dissolve hydrogen sulfide in the condensation to thereby suppress diffusion of hydrogen sulfide. This suppression helps to reduce an influence of hydrogen sulfide on a person such an occupant of the vehicle.

In some embodiments, the medium circulator of the battery detoxification apparatus may include a separator disposed between the battery cells. Such a configuration of the separator serving also as the medium circulator helps to detoxify hydrogen sulfide while suppressing an increase in the number of components.

In some embodiments, the medium circulator of the battery detoxification apparatus may include a refrigerant circuit. The refrigerant circuit may be configured to allow a refrigerant used in a vapor-compression refrigeration cycle to circulate therethrough. Such a configuration in which the medium circulator is cooled with the refrigerant helps to effectively generate condensation around the medium circulator.

In some embodiments, the cooling medium of the battery detoxification apparatus may include cooling water. The medium cooler may include a cooling water circuit including a heat exchanger. The cooling water circuit may be configured to allow the cooling water to circulate therethrough. The heat exchanger may be configured to perform a heat exchange between the cooling water and a refrigerant used in a vapor-compression refrigeration cycle. Such a simple configuration helps to effectively generate condensation around the medium circulator.

In some embodiments, the medium circulator of the battery detoxification apparatus may have an H-shaped cross-section. Such a configuration of the medium circulator having the H-shaped cross-section helps to increase a surface area of the medium circulator to thereby generate a large amount of condensation.

Although the disclosure has been described hereinabove in terms of the example embodiments and modification examples, the disclosure is not limited thereto. It should be appreciated that variations may be made in the described example embodiments and modification examples by those skilled in the art without departing from the scope of the disclosure as defined by the following claims. Further, the foregoing example embodiments may be combined with each other.

The limitations in the claims are to be interpreted broadly based on the language employed in the claims and not limited to examples described in this specification or during the prosecution of the application, and the examples are to be construed as non-exclusive.

As used in this specification and the appended claims, the singular forms "a", "an", and "the" include, especially in the context of the claims, are to be construed to cover both the singular and the plural, unless otherwise indicated herein or clearly contradicted by context.

Throughout this specification and the appended claims, unless the context requires otherwise, the terms "comprise", "include", "have", and their variations are to be construed to cover the inclusion of a stated element, integer, or step but not the exclusion of any other non-stated element, integer, or step.

The use of the terms first, second, etc. do not denote any order or importance, but rather the terms first, second, etc. are used to distinguish one element from another.

The term "substantially", "approximately", "about", and its variants having the similar meaning thereto are defined as being largely but not necessarily wholly what is specified as understood by one of ordinary skill in the art.

The term "disposed on/ provided on/ formed on" and its variants having the similar meaning thereto as used herein refer to elements disposed directly in contact with each other or indirectly by having intervening structures therebetween.

As used herein, the term "collision" may be used interchangeably with the term "contact".

According to at least one embodiment of the disclosure, a cooled cooling medium is circulated through a medium circulator upon a detector detecting generation of hydrogen sulfide from a solid-state battery. This helps to generate condensation on a surface of the medium circulator and dissolve hydrogen sulfide in the condensation to thereby suppress diffusion of hydrogen sulfide. Such low-cost measures help to prevent an influence of hydrogen sulfide on a person such as an occupant of a vehicle.

The calculation processor 24 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the calculation processor 24 illustrated in FIG. 1. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the calculation processor 24 illustrated in FIG. 1.

1. A battery detoxification apparatus comprising:
a medium circulator disposed between battery cells, the medium circulator being configured to allow a cooling medium to circulate therethrough, the battery cells each comprising a sulfide;
a medium cooler configured to cool the cooling medium;
a detector configured to detect generation of hydrogen sulfide from the battery cells; and
a calculation processor configured to, when the detector detects the generation of the hydrogen sulfide, perform control of generating condensation on a surface of the medium circulator by circulating the cooling medium cooled by the medium cooler through the medium circulator.

2. The battery detoxification apparatus according to claim 1, wherein the medium circulator comprises a separator disposed between the battery cells.

3. The battery detoxification apparatus according to claim 1, wherein the medium circulator comprises a refrigerant circuit, the refrigerant circuit being configured to allow a refrigerant used in a vapor-compression refrigeration cycle to circulate therethrough.

4. The battery detoxification apparatus according to claim 1, wherein
the cooling medium comprises cooling water, and
the medium cooler comprises a cooling water circuit comprising a heat exchanger, the cooling water circuit being configured to allow the cooling water to circulate therethrough, the heat exchanger being configured to perform a heat exchange between the cooling water and a refrigerant used in a vapor-compression refrigeration cycle.

5. The battery detoxification apparatus according to claim 1, wherein the medium circulator comprises an H-shaped cross-section.

6. The battery detoxification apparatus according to claim 1, further comprising
a battery pack housing configured to house the battery cells, wherein
the calculation processor is configured to
determine whether the condensation is generatable in an internal environment of the battery pack housing, when the detector detects the generation of the hydrogen sulfide, and
perform control of,
when the condensation is generatable, generating the condensation on a surface of the medium circulator by circulating the cooling medium cooled by the medium cooler through the medium circulator, and,
when the condensation is not generatable, generating the condensation on the surface of the medium circulator by circulating the cooling medium cooled by the medium cooler through the medium circulator after increasing a moisture content of the internal environment of the battery pack housing to a saturated water vapor content.
